(19) United States
(12) Patent Application Publication
(10) Pub. No.: US 2026/0005361 A1
(43) Pub. Date: Jan. 1, 2026

(54) COMPOSITE SYSTEM FOR BATTERY ENCLOSURE

(71) Applicant: Industrial Dielectrics, Inc., Noblesville, IN (US)

(72) Inventors: Kevin M. CAHILL, Fishers, IN (US); Do Hyun KIM, Noblesville, IN (US); Alec HUECKEL, Noblesville, IN (US)

(21) Appl. No.: 19/249,383

(22) Filed: Jun. 25, 2025

Related U.S. Application Data
(60) Provisional application No. 63/664,339, filed on Jun. 26, 2024.

(51) Int. Cl. H01M 50/24; B32B 5/02; B32B 27/12; B32B 27/18; B32B 27/30; B32B 27/36; B32B 27/38; C08K 3/016; C08K 7/06; C08K 7/14; H01M 50/224; H01M 50/227; H01M 50/231

(52) U.S. Cl. CPC H01M 50/24; B32B 5/022; B32B 5/024; B32B 27/12; B32B 27/18; B32B 27/30; B32B 27/36; B32B 27/38; C08K 3/016; C08K 7/06; C08K 7/14; H01M 50/224; H01M 50/227; H01M 50/231; B32B 2260/021; B32B 2260/046; B32B 2262/02; B32B 2262/101; B32B 2262/103; B32B 2262/106; B32B 2264/10; B32B 2264/1023; B32B 2264/104; B32B 2307/212; B32B 2307/3065; B32B 2307/54; B32B 2307/546; B32B 2307/7376; B32B 2457/10

(57) ABSTRACT

A composite system and methods for using and preparing a composite system including a flame-retarding layer and shielding layer is described.

### RELATED APPLICATIONS

This application claims priority under 35 U.S.C. § 119(e) of U.S. Provisional Application No. 63/664,339, filed Jun. 26, 2024, the entire disclosure of which is incorporated herein by reference.

### BACKGROUND

The present disclosure relates to composite systems, and particularly to composite systems for use in molded components. More particularly, the present disclosure relates to composite systems including a sheet molding compound including resin and fiber.

### SUMMARY

According to the present disclosure, a composite system is used to form a battery enclosure therein. The composite system includes a flame-retarding layer and a shielding layer. The flame-retarding layer includes a molding formulation and a fiber. In one illustrative embodiment, the flame-retarding layer includes a flame retarding grade sheet molding compound (SMC) comprising the molding formulation and the fiber. The shielding layer includes a molding formulation and a metallic fabric. The metallic fabric, for example, may include a metal. In one illustrative embodiment, the present disclosure provides a battery enclosure comprising a composite system according to the present disclosure.

In one illustrative embodiment, the present disclosure provides a composite system including a flame-retarding layer and a shielding layer, the flame-retarding layer arranged to form an interior surface of a battery enclosure and the shielding layer is arranged to form an exterior surface of a battery enclosure. In some embodiments, the flame-retarding layer is arranged to form an interior surface of a battery enclosure and to directly contact a battery. The flame-retarding layer includes a molding formulation and a fiber, and the shielding layer includes a molding formulation and a metallic fabric.

In yet another illustrative embodiment, the present disclosure provides a method of using a composite system according to the present disclosure. In some embodiments, the method includes using the composite system for fire retardation of a battery enclosure. In some embodiments, the method includes using the composite system for fire retardation of a battery enclosure, for shielding of a battery enclosure, or a combination thereof.

In another illustrative embodiment, the present disclosure provides a method of preparing a composite system, the method including a step of compression molding a flame-retarding layer and a shielding layer. For example, the method of compression molding includes co-molding the flame-retarding layer and a shielding layer simultaneously.

In yet another illustrative embodiment, a compression molding manufacturing process provides a composite system including a flame-retarding layer and a shielding layer. The flame-retarding layer includes a molding formulation and a fiber, and the shielding layer includes a molding formulation and a metallic fabric.

In yet another illustrative embodiment, a composite system including a flame-retarding layer and a shielding layer is made in a compression molding manufacturing process. The compression molding manufacturing process provides the composite system including a flame-retarding layer and a shielding layer. The flame-retarding layer includes a molding formulation and a fiber, and the shielding layer includes a molding formulation and a metallic fabric.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a diagrammatic view of an embodiment of a composite system 10 in accordance with the present disclosure showing that the composite system includes, from top to bottom, a flame-retarding layer 2 and a shielding layer 6;

FIG. 2 is perspective view of a battery enclosure 20 made from a composite system in accordance with the present disclosure showing that the battery enclosure 20 includes a cavity 26 formed to include an interior battery-storage region for storing battery 30, a housing 22 formed from a composite system according to the present disclosure, as shown in FIG. 3, and a cover 24 formed from a composite system according to the present disclosure;

FIG. 3 is a diagrammatic view of an embodiment of a composite system in accordance with the present disclosure showing that composite system 10 includes, from inner surface to outer surface, a flame-retarding layer 2 and a shielding layer 6;

FIG. 4 is a diagrammatic view of an embodiment of a composite system in accordance with the present disclosure showing that composite system 12 includes, from inner surface to outer surface, a shielding layer 6 and a flame-retarding layer 2;

FIG. 5 is a diagrammatic view of an embodiment of a composite system in accordance with the present disclosure showing that composite system 14 includes, from inner surface to outer surface, a first shielding layer 46, a flame-retarding layer 42, and a second shielding layer 48;

FIG. 6 is a diagrammatic view of an open-configuration compression mold 40 including a top plate 32 and a bottom plate 34 configured to form an interior region 50. The interior region 50 includes a pre-formed shielding layer charge 56 and a pre-formed flame retarding layer charge 52. The compression mold includes a guide pin 36 and a guide bushing 38;

FIG. 7 is a diagrammatic view of an open-configuration compression mold 40 including a top plate 32 and a bottom plate 34 configured to form an interior region 50. The interior region 50 includes a pre-laminated composite charge 74 including a pre-formed shielding layer charge 76 and a pre-formed flame retarding layer charge 72. The compression mold includes a guide pin 36 and a guide bushing 38;

FIG. 8 is a diagrammatic view of a closed-configuration compression mold 60. An applied pressure 58 and optional heat compresses the top plate 32 and the bottom plate 34 together, directing the guide pin 36 into the guide bushing 38 thereby forming a composite system in accordance with the present disclosure. The composite system 54 includes, from top to bottom, a shielding layer 66 and a flame-retarding layer 62.

### DETAILED DESCRIPTION

A composite system produced in accordance with the present disclosure can be formed by a compression co-molding manufacturing process. In one illustrative embodiment, a compression co-molding manufacturing process provides a composite system, such as composite system 10 as shown in FIG. 1.

A composite system produced in accordance with the present disclosure includes a flame-retarding layer and a shielding layer, which can be processed by a compression molding process or any other suitable process, to form a battery enclosure. A method for manufacturing a battery enclosure based on a composite system produced in accordance with the present disclosure is as described herein.

In some embodiments, the compression co-molding manufacturing process includes compression molding two independent pre-formed layers, such as a precursor flame-retarding layer and a precursor shielding layer, to form a composite system. In some embodiments, the compression co-molding manufacturing process includes compression molding a precursor composite comprising a precursor flame-retarding layer and a precursor shielding layer, wherein the precursor flame-retarding layer and the precursor shielding layer are laminated together, to form a composite system. In some embodiments, the compression co-molding manufacturing process includes a step of laminating a precursor flame-retarding layer and a precursor shielding layer to form a composite system. In some embodiments, the compression co-molding manufacturing process includes adhering a precursor flame-retarding layer and a precursor shielding layer to form a composite system.

In some embodiments, the precursor flame-retarding layer and the precursor shielding layer may be adhered together by any suitable molding or laminating process as described herein, such as compression molding, transfer molding, and injection molding. In one example, the precursor flame-retarding layer and the precursor shielding layer are adhered together in a compression molding process. In some embodiments, the precursor flame-retarding layer and the precursor shielding layer are adhered directly using pressure, heat, or combination, without the use of an adhesive. In some embodiments, the precursor flame-retarding layer and the precursor shielding layer can be co-molded under the same processing conditions because they include the same resin reaction kinetic components.

In some embodiments, a composite system in accordance with the present disclosure is prepared in a method (e.g., a compression co-molding manufacturing process) comprising compression molding a precursor flame-retarding layer (e.g., an uncured flame-retarding layer) and a precursor shielding layer (e.g., an uncured shielding layer). In some embodiments, the compression molding is performed in a compression mold. In some embodiments, the compression molding comprises compression co-molding the precursor flame-retarding layer and the precursor shielding layer simultaneously. In some embodiments, the compression molding comprises curing the precursor flame-retarding layer and the precursor shielding layer.

In some embodiments, a composite system in accordance with the present disclosure is prepared in a method comprising providing a precursor flame-retarding layer and a precursor shielding layer. In some embodiments, the method comprises placing each of the precursor flame-retarding layer and the precursor shielding layer in a compression mold. In some embodiments, the method comprises contacting the precursor flame-retarding layer with the precursor shielding layer. In some embodiments, contact between the precursor flame-retarding layer and the precursor shielding layer may be direct contact, such that no intervening adhesive is used.

In one example, the contacting of the precursor flame-retarding layer with the precursor shielding layer may occur prior to placing the precursor layers in the compression mold, such as in a lamination process that provides a precursor composite comprising the precursor flame-retarding layer and the precursor shielding layer.

In another example, the contacting of the precursor flame-retarding layer with the precursor shielding layer may occur at the same time as placing each of the precursor layers in the compression mold.

In some embodiments, the method comprises curing the precursor flame-retarding layer and the precursor shielding layer, thereby providing the composite system in accordance with the present disclosure. In some embodiments, curing comprises adhering the flame-retarding layer and the shielding layer, thereby providing the composite system in accordance with the present disclosure.

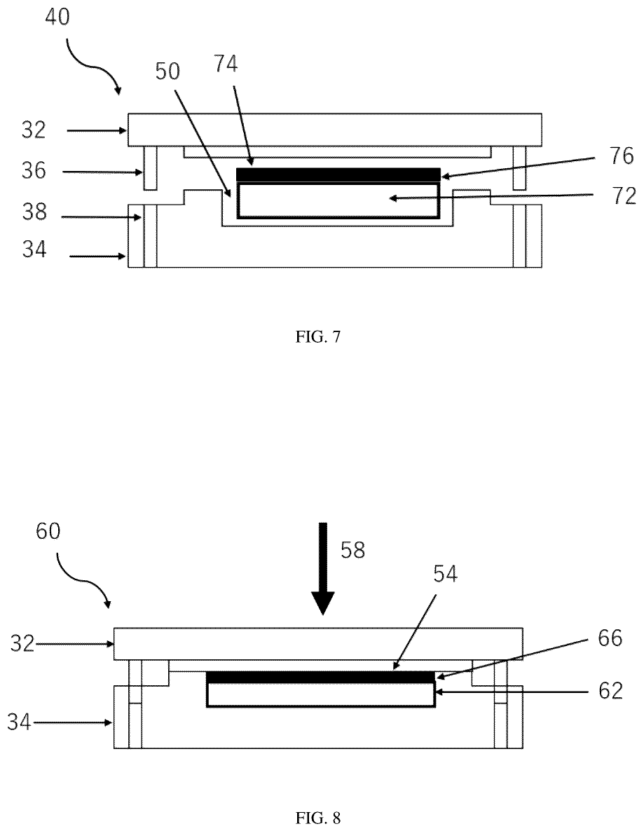

In one embodiment, the co-molding manufacturing process includes the use of a compression mold. In one embodiment, the compression co-molding manufacturing process includes the conversion of a compression mold in an open configuration as shown in FIG. 6 and FIG. 7 to a closed configuration compression mold as shown in FIG. 8. As shown in FIG. 6, a precursor shielding layer charge 56 (e.g., an uncured shielding layer) and a precursor flame retarding layer charge 52 (e.g., an uncured flame-retarding layer) may be placed in direct contact with one another in an interior region 50 located between a top plate 32 and a bottom plate 34 of an open-configuration compression mold 40. An applied pressure 58 and optional heat compresses the top plate 32 and the bottom plate 34 directing the guide pin 36 into the guide bushing 38 as shown in FIG. 8. During the compression co-molding manufacturing process, precursor shielding layer charge 56 and a precursor flame retarding layer charge 52 may flow from center to edge of the compressed interior region of the mold. In some embodiments, the precursor shielding layer charge 56 is extended by about 1-5% (length increase to the resin flow direction) to form the shielding layer 66 of composite system 54. In some embodiments, the precursor flame retarding layer charge 52 may have different resin flow than the precursor shielding layer charge 56. In some embodiments, the precursor flame retarding layer charge 52 is extended by about 20-50% (length increase to the resin flow direction) to form the flame retarding layer 62 of composite system 54.

In one example as shown in FIG. 6, if the precursor flame retarding layer charge 52 (e.g., an uncured flame-retarding layer) is thicker than the targeted thickness ratio of the flame-retarding layer 62 to the shielding layer 66 in the composite, each of the precursor flame retarding layer charge and the precursor shielding layer charge need to be layup in the compression mold in a designated mass (volume) amount to meet the target layer thicknesses of the composite.

In another example as shown in FIG. 7, the precursor flame retarding layer charge 72 and the precursor shielding layer charge may be pre-laminated (e.g., prior to placing in the compression mold) to provide a precursor composite charge 74 including the precursor flame retarding layer 72 and the precursor shielding layer 76. The precursor composite charge 74 may include the precursor flame retarding layer charge 72 at the targeted thickness ratio of the flame-retarding layer 62 to the shielding layer 66 in the composite. The precursor composite charge 74 may be placed in an interior region 50 located between a top plate 32 and a bottom plate 34 of an open-configuration compression mold 40. An applied pressure 58 and optional heat compresses the top plate 32 and the bottom plate 34 directing the guide pin 36 into the guide bushing 38 as shown in FIG. 8. During the compression co-molding manufacturing process, the precursor composite charge 74 may flow from center to edge of the compressed interior region of the mold to form a composite system according to the present disclosure. The co-molding manufacturing process conditions (e.g., heat and pressure) may be selected to minimize damage to the shielding layer.

In some embodiments, curing comprises heating the uncured layers (e.g., the precursor flame-retarding layer and the precursor shielding layer) at a temperature of greater than 120° C., such as 150° C. For example, the temperature may be about 120° C. to about 200° C.

In some embodiments, curing comprises heating the uncured layers (e.g., the precursor flame-retarding layer and the precursor shielding layer) for a cycle time of about 2 minutes to about 5 minutes, such as about 3 minutes.

In some embodiments, curing comprises applying a pressure to the uncured layers (e.g., the precursor flame-retarding layer and the precursor shielding layer) of greater than about 1000 psi. For example, the pressure may be about 1000 psi to about 2000 psi.

In some embodiments, composite system 10 may comprise a composition. In one embodiment, composite system 10, for example, is a composite system in which a flame-retarding layer 2 and a shielding layer 6 each comprise a composition. In some embodiments, the flame-retarding layer and the shielding layer are in direct contact, such that no adhesive is used. In one embodiment, flame-retarding layer 2 and shielding layer 6 each comprise a composition including a compatible resin. An example of a compatible resin is a resin that will adhere without the addition of an adhesive. For example, a compatible resin may be the same resin or a different resin that will adhere without the addition of an adhesive. In some embodiments, the flame-retarding layer and the shielding layer each comprise the same resin. In some embodiments, the flame-retarding layer and the shielding layer can be co-molded under the same processing conditions without an adhesive because each of the flame-retarding layer and the shielding layer include the same resin reaction kinetic components.

In some illustrative embodiments, a composite system in accordance with the present disclosure may include any suitable number of laminated layers, such as 2 laminated layers, 3 laminated layers, and 4 laminated layers. In some illustrative embodiments, composite system 10 may include any suitable number of laminated layers, such as 2 laminated layers, 3 laminated layers, and 4 laminated layers. In some illustrative embodiments, a composite system in accordance with the present disclosure may include any suitable number of co-molded layers, such as 2 co-molded layers, 3 co-molded layers, and 4 co-molded layers. In some illustrative embodiments, composite system 10 may include any suitable number of co-molded layers, such as 2 co-molded layers, 3 co-molded layers, and 4 co-molded layers. However, any suitable number of layers may be used in composite systems of the present disclosure. Composite system may include a particular number of co-molded layers. In one embodiment, composite system 10 includes 2 co-molded layers. In another example, the composite system may comprise 3 co-molded layers. In another example, the composite system may comprise any suitable number of total layers, or it can be advantageous to limit the number of total layers according to composite manufacturing capabilities. The composite system may comprise 2, 3, or 4 co-molded layers, for example 2 co-molded layers.

In one embodiment, the composite system according to the present disclosure is in direct contact with a battery. In one embodiment, the battery enclosure formed from composite system 10 comprises an inner surface and an outer surface. The inner surface of the formed battery enclosure is arranged to be in contact with the battery. The outer surface may be arranged opposite to the inner surface.

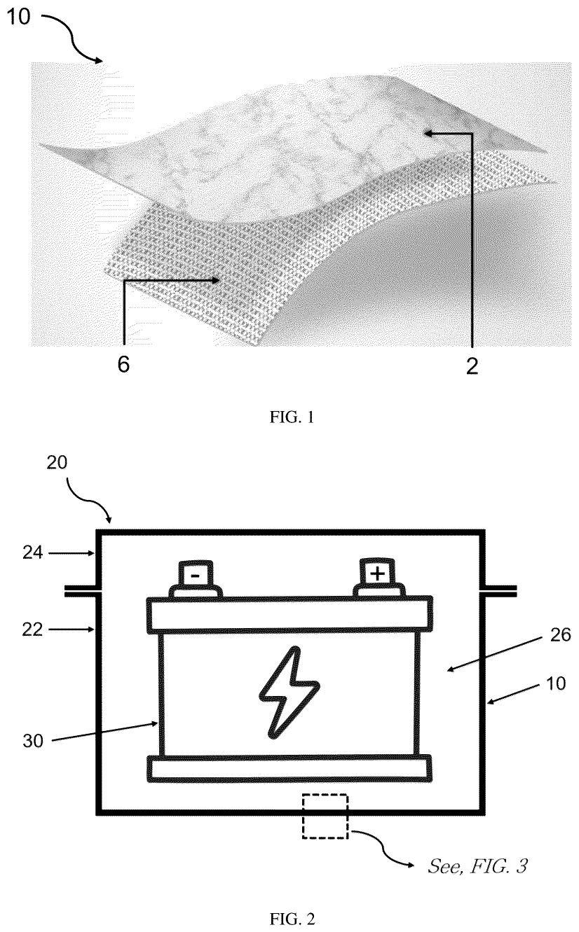

In some embodiments, a battery enclosure 20 includes a cavity or interior region 26 for storing a battery 30, and a housing 22 formed from a composite system according to the present disclosure, as shown in FIG. 2. The cavity or interior region 26, for example, may be configured to store a battery or a rechargeable power cell. The battery enclosure 20 may include a cover 24 formed from a composite system according to the present disclosure. In one embodiment, the housing formed from composite system 10 comprises an inner surface and an outer surface. The inner surface of the housing is arranged to be in contact with the cavity or interior region 26 for storing a battery 30.

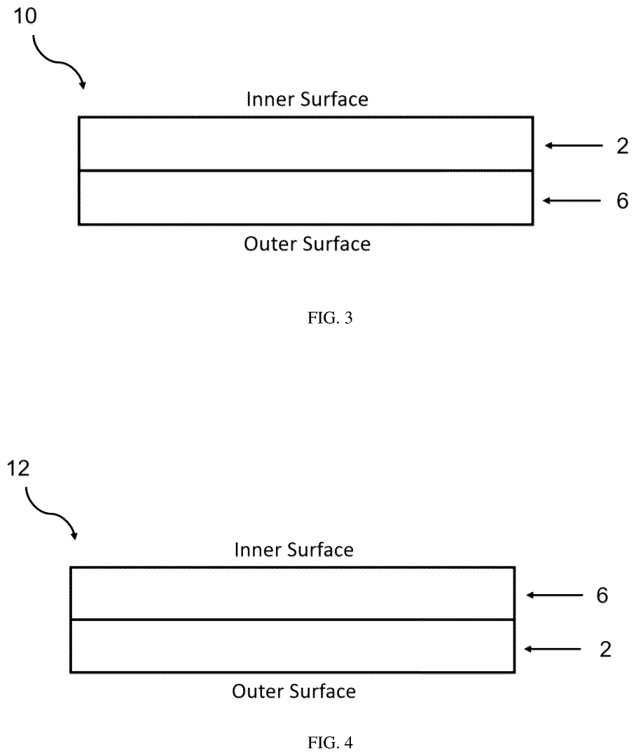

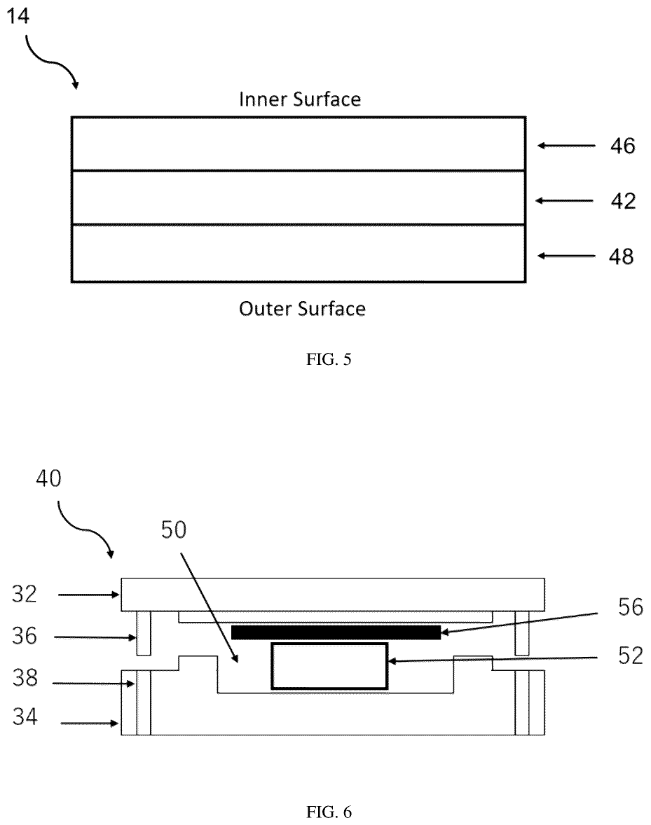

In some embodiments, a battery enclosure 20 formed from a composite system according to the present disclosure may include any suitable arrangement of layers according to the device use and case molding direction. The individual layers of the composite system according to the present disclosure are as described herein. In one embodiment, a composite system 10 includes flame-retarding layer 2 arranged to form an inner surface of the formed battery enclosure, and shielding layer 6 arranged to form an outer surface of the formed battery enclosure, as shown in FIG. 3. Without being bound by any theory, the shielding layer as arranged to form an outer surface of a battery enclosure may provide protection from outer field interference. In another embodiment, a composite system 12 includes flame-retarding layer 2 arranged to form an outer surface of the formed battery enclosure, and shielding layer 6 arranged to form an inner surface of the formed battery enclosure, as shown in FIG. 4. Without being bound by any theory, the shielding layer as arranged to form an inner surface of a battery enclosure may provide protection from interior noise. In another embodiment, a composite system includes the flame-retarding layer and the shielding layer arranged to form a 3-layer sandwich. In one example, a composite system 14 includes two shielding layers arranged to form an inner surface and an outer surface (i.e., skin layers) of the formed battery enclosure, and a flame-retarding layer arranged to form a core layer arranged between the skin layers of the formed battery enclosure. For example, composite system 14 includes a first shielding layer 46 arranged to form an inner surface (i.e., a first skin layer), a second shielding layer 48 arranged to form an outer surface (i.e., a second skin layer 48), and a flame-retarding layer 42 to form a core layer of the formed battery enclosure, as shown in FIG. 5. In another example, a composite system includes two flame-retarding layers arranged to form an inner surface and an outer surface (i.e., skin layers) of the formed battery enclosure, and a shielding layer arranged to form a core layer arranged between the skin layers of the formed battery enclosure. For example, a composite system includes a first flame-retarding layer arranged to form an inner surface (i.e., a first skin layer), a second flame-retarding layer arranged to form an outer surface (i.e., a second skin layer), and a shielding layer arranged to form a core layer of the formed battery enclosure.

### Flame-Retarding Layer.

In some embodiments, the flame-retarding layer (and/or precursor flame-retarding layer) of the composite system comprises a sheet molding compound (SMC) or composite, such as a flame retarding grade SMC. In some embodiments, the SMC comprises, for example, a resin and a fiber. In one example, the sheet molding compound (SMC) is a ready to mold glass-fiber reinforced polymer material (e.g., resin) primarily used in compression molding. In some embodiments, the polymer is a thermoset resin, for example, polyester resin, vinyl ester resin, or epoxy resin. One exemplary SMC sheet is available in rolls weighing up to 2000 lb. Alternatively, SMC components, such as resin, fiber, and related materials, can be mixed on site for greater control over the chemistry and filler.

In some embodiments, an SMC is manufactured by dispersing chopped fiber (i.e., greater than about 0.5″) of long strands, commonly glass fibers or carbon fibers on a bath of thermoset resin. In some embodiments, the longer fibers in SMC result in better strength properties than comparative bulk molding compound (BMC) products.

In some embodiments, the flame-retarding layer of the composite system comprises a flame-retarding grade SMC. In some embodiments, the flame-retarding grade SMC comprises the molding formulation and the fiber. In some embodiments, the flame-retarding grade SMC is uncured. In some embodiments, the flame-retarding layer may comprise FLAMEVEX™ available from IDI Composites International.

In some embodiments, the flame-retarding layer (and/or precursor flame-retarding layer) of the composite system comprises, for example, a molding formulation and a fiber. In some embodiments, the molding formulation of the flame-retarding layer (and/or precursor flame-retarding layer) of the composite system may comprise a resin and a particle. In some embodiments, the flame-retarding layer (and/or precursor flame-retarding layer) of the composite system comprises, for example, a resin, a particle, and a fiber. In some embodiments, the flame-retarding layer of the composite system is an uncured flame-retarding layer (e.g., precursor flame-retarding layer) or a cured flame-retarding layer. In some embodiments, the precursor flame-retarding layer of the composite system is an uncured flame-retarding layer. A precursor flame-retarding layer or an uncured flame-retarding layer, for example, may refer to a flame-retarding grade SMC. In some embodiments, the flame-retarding layer of the composite system comprises a cured composition of the precursor flame-retarding layer.

In some embodiments, the fiber of the flame-retarding layer (and/or precursor flame-retarding layer) of the composite system may comprise a carbon fiber, a glass fiber, any other suitable alternative, or any suitable combination thereof. Examples of suitable glass fiber, include but are not limited to, AES glass, E glass, ECR glass, silica glass, S glass, R glass, M glass, C glass, D glass, AR glass, T glass, Q glass, and the like.

In some embodiments, the fiber is distributed throughout the molding formulation or impregnated with the molding formulation. In some embodiments, the fiber, such as a discontinuous fiber, is distributed (e.g., in random orientations) throughout the flame-retarding layer. For example, the discontinuous fiber may be homogenously distributed throughout the flame-retarding layer. In some embodiments, the fiber is impregnated with the molding formulation.

In some embodiments, the fiber includes a discontinuous fiber, a continuous fiber, or combination thereof. A discontinuous fiber includes, but is not limited to, of chopped fiber, commonly glass fibers or carbon fibers. In some embodiments, the discontinuous fiber of the flame-retarding layer may comprise E glass (e.g., about 25 mm chopped E glass). In some embodiments, the discontinuous fiber is a plurality of discontinuous fibers distributed (e.g., in random orientations) throughout the molding formulation.

In some embodiments, the fiber includes a discontinuous fiber and optionally a continuous fiber. For example, a flame-retarding layer including a discontinuous fiber could be modified with continuous fiber reinforcement, including but not limited to, a plain weave fabric or triaxial braided fabric to provide a hybrid fiber composition. In some embodiments, the continuous fiber of the flame-retarding layer may be pre-impregnated with the molding formulation, or the molding formulation and discontinuous fiber. In some embodiments, the continuous fiber of the flame-retarding layer may comprise QISOR Fabric available from A&P Technology.

In some embodiments, the resin of the flame-retarding layer (and/or precursor flame-retarding layer) of the composite system may comprise a thermoset resin. Examples of plastic polymers or resins suitable for forming the flame-retarding layer of the composite system include a polyester resin, vinyl ester resin, epoxy resin, and the like. In some embodiments, the resin of flame-retarding layer of the composite system may comprise an unsaturated polyester resin. In some embodiments, the thermoset resin comprises an additive, such as a catalyst (e.g., an initiator and/or a curing agent).

In some embodiments, the particle of the flame-retarding layer (and/or precursor flame-retarding layer) of the composite system may comprise a flame-retardant agent. Flame-retardant agents may be chemicals applied to materials to prevent burning or slow the spread of fire. Examples of flame-retardant agents suitable for forming the flame-retarding layer of the composite system include selected from the group consisting of aluminum trihydrate (ATH, also referred to as alumina trihydrate), calcium carbonate, and the like.

In some embodiments, the flame-retarding layer (and/or precursor flame-retarding layer) of the composite system may optionally include one or more additives. Additives including, but not limited to, catalysts (e.g., an initiator and/or a curing agent), inhibitors, coloring agents, and wetting agents may be added to the molding formulation to improve the molding process and provide additional properties to the composite system. Examples of catalysts (e.g., initiators and/or curing agents) suitable for the molding formulation of the composite system are organic peroxides, such as methyl ethyl ketone peroxide, t-butylperoxybenzoate (TBPB), benzoyl peroxide and cumene hydroperoxide (CHP), benzyl trimethyl ammonium chloride (BTMAC) or TBPB/t-butyl peroxy octoate (TBPO), available from Nouryon Products.

In some embodiments, the flame-retarding layer (and/or precursor flame-retarding layer) of the composite system may comprise a weight percentage of fiber. The weight percent of fiber in the flame-retarding layer may be one of several different percentages or fall within one of several different ranges. In some embodiments, the flame-retarding layer comprises a weight percent of about 30% to about 60% of fiber. In some embodiments, the flame-retarding layer comprises a weight percent of about 10% to about 50% of fiber. The weight percent of the fiber in the flame-retarding layer may be one of the following values: about 30%, about 35%, about 40%, about 45%, about 50%, about 55%, and about 60%. It is within the present disclosure for the weight percent of the fiber to fall within one of the following ranges: greater than about 10%, greater than about 15%, greater than about 20%, greater than about 25%, greater than about 30%, greater than about 35%, greater than about 40%, greater than about 45%, greater than about 50%, greater than about 55%, less than about 60%, less than about 55%, less than about 50%, less than about 45%, less than about 40%, less than about 35%, about 10% to about 60%, about 10% to about 50%, about 10% to about 40%, about 30% to about 60%, about 30% to about 55%, about 30% to about 50%, about 30% to about 45%, about 30% to about 40%, about 30% to about 35%, about 40% to about 60%, about 40% to about 55%, about 40% to about 50%, about 40% to about 45%, about 45% to about 60%, about 45% to about 55%, about 45% to about 50%, about 50% to about 60%, and about 55% to about 60%.

In some embodiments, the flame-retarding layer (and/or precursor flame-retarding layer) of the composite system may comprise a weight percentage of resin. The weight percent of resin in the flame-retarding layer may be one of several different percentages or fall within one of several different ranges. In some embodiments, the flame-retarding layer comprises a weight percent of about 10% to about 40% of resin. The weight percent of the resin in the flame-retarding layer may be one of the following values: about 10%, about 15%, about 20%, about 25%, about 30%, about 35%, and about 40%. It is within the present disclosure for the weight percent of the resin to fall within one of the following ranges: greater than about 10%, greater than about 15%, greater than about 20%, greater than about 25%, greater than about 30%, greater than about 35%, less than about 40%, less than about 35%, less than about 30%, less than about 25%, less than about 20%, less than about 15%, about 10% to about 40%, about 10% to about 35%, about 10% to about 30%, about 10% to about 25%, about 10% to about 20%, about 10% to about 15%, about 20% to about 40%, about 20% to about 35%, about 20% to about 30%, about 20% to about 25%, about 25% to about 40%, about 25% to about 35%, about 25% to about 30%, about 30% to about 40%, and about 35% to about 40%.

In some embodiments, the flame-retarding layer (and/or precursor flame-retarding layer) of the composite system may comprise a weight percentage of particle. The weight percent of particle in the flame-retarding layer may be one of several different percentages or fall within one of several different ranges. In some embodiments, the flame-retarding layer comprises a weight percent of about 20% to about 40% of particle. The weight percent of the particle in the flame-retarding layer may be one of the following values: about 20%, about 25%, about 30%, about 35%, and about 40%. It is within the present disclosure for the weight percent of the particle to fall within one of the following ranges: greater than about 20%, greater than about 25%, greater than about 30%, greater than about 35%, less than about 40%, less than about 35%, less than about 30%, less than about 25%, about 20% to about 40%, about 20% to about 35%, about 20% to about 30%, about 20% to about 25%, about 25% to about 40%, about 25% to about 35%, about 25% to about 30%, about 30% to about 40%, and about 35% to about 40%.

In some embodiments, the flame-retarding layer (and/or precursor flame-retarding layer) of the composite system may comprise a weight percentage of additive. The weight percent of additive in the flame-retarding layer may be one of several different percentages or fall within one of several different ranges. In some embodiments, the flame-retarding layer comprises a weight percent of less than about 5% of additive. The weight percent of the additive in the flame-retarding layer may be one of the following values: about 0.1%, about 0.5%, about 1%, about 2%, about 3%, about 4%, and about 5%. It is within the present disclosure for the weight percent of the additive to fall within one of the following ranges: less than about 5%, less than about 4%, less than about 3%, less than about 2%, less than about 1%, less than about 0.5%, about 0.1% to about 5%, about 0.1% to about 4%, about 0.1% to about 3%, about 0.1% to about 2%, about 0.1% to about 1%, about 1% to about 5%, about 1% to about 4%, about 1% to about 3%, and about 1% to about 2%.

In some embodiments, the molding formulation of the flame-retarding layer (and/or precursor flame-retarding layer) of the composite system may comprise a weight percentage of resin. The weight percent of resin in the molding formulation may be one of several different percentages or fall within one of several different ranges. In some embodiments, the molding formulation comprises a weight percent of about 60% to about 95% of resin. The weight percent of the resin in the molding formulation may be one of the following values: about 60%, about 65%, about 70%, about 75%, about 80%, about 85%, about 90%, and about 95%. It is within the present disclosure for the weight percent of the resin to fall within one of the following ranges: greater than about 50%, greater than about 60%, greater than about 65%, greater than about 70%, greater than about 75%, less than about 95%, less than about 90%, less than about 85%, less than about 80%, about 60% to about 90%, about 60% to about 85%, about 60% to about 80%, about 70% to about 95%, about 70% to about 90%, about 70% to about 85%, and about 70% to about 80%.

In some embodiments, the molding formulation of the flame-retarding layer (and/or precursor flame-retarding layer) of the composite system may comprise a weight percentage of a particle. The weight percent of particle in the molding formulation may be one of several different percentages or fall within one of several different ranges. In some embodiments, the molding formulation comprises a weight percent of about 5% to about 40% of particle. The weight percent of the particle in the molding formulation may be one of the following values: about 5%, about 10%, about 15%, about 20%, about 25%, about 30%, about 35%, and about 40%. It is within the present disclosure for the weight percent of the particle to fall within one of the following ranges: greater than about 5%, greater than about 10%, greater than about 15%, greater than about 20%, less than about 40%, less than about 35%, less than about 30%, less than about 25%, about 5% to about 35%, about 5% to about 30%, about 5% to about 25%, about 10% to about 40%, about 10% to about 35%, about 10% to about 30%, and about 10% to about 25%.

In some embodiments, the molding formulation of the flame-retarding layer (and/or precursor flame-retarding layer) of the composite system may comprise a weight percentage of additive. The weight percent of additive in the molding formulation may be one of several different percentages or fall within one of several different ranges. In some embodiments, the molding formulation comprises a weight percent of less than about 5% of additive. The weight percent of the additive in the molding formulation may be one of the following values: about 0.1%, about 0.5%, about 1%, about 2%, about 3%, about 4%, and about 5%. It is within the present disclosure for the weight percent of the additive to fall within one of the following ranges: less than about 5%, less than about 4%, less than about 3%, less than about 2%, less than about 1%, less than about 0.5%, about 0.1% to about 5%, about 0.1% to about 4%, about 0.1% to about 3%, about 0.1% to about 2%, about 0.1% to about 1%, about 1% to about 5%, about 1% to about 4%, about 1% to about 3%, and about 1% to about 2%.

In some embodiments, the flame-retarding layer (and/or precursor flame-retarding layer) of the composite system may comprise a weight percentage of the molding formulation. The weight percent of molding formulation in the flame-retarding layer may be one of several different percentages or fall within one of several different ranges. In some embodiments, the flame-retarding layer comprises a weight percent of about 10% to about 99% of molding formulation. In some embodiments, the flame-retarding layer comprises a weight percent of about 10% to about 99% of molding formulation. The weight percent of the molding formulation in the flame-retarding layer may be one of the following values: about 10%, about 15%, about 20%, about 25%, about 30%, about 35%, about 40%, about 45%, about 50%, about 55%, about 60%, about 65%, about 70%, about 75%, about 80%, about 85%, about 90%, and about 95%. It is within the present disclosure for the weight percent of the molding formulation to fall within one of the following ranges: greater than about 10%, greater than about 25%, greater than about 50%, less than about 99%, less than about 95%, less than about 90%, less than about 75%, about 10% to about 95%, about 10% to about 75%, about 10% to about 50%, about 25% to about 99%, about 25% to about 95%, about 25% to about 90%, about 25% to about 75%, about 25% to about 50%, about 50% to about 99%, about 50% to about 95%, about 50% to about 90%, about 50% to about 75%, and about 50% to about 25%.

In some embodiments, the flame-retarding layer (and/or precursor flame-retarding layer) of the composite system may comprise about 30 wt. % to about 60 wt. % fiber, about 10 wt. % to about 40 wt. % resin, and about 20 wt. % to about 40 wt. % particle. In some embodiments, the flame-retarding layer of the composite system may comprise about 30 wt. % to about 60 wt. % glass fiber, about 10 wt. % to about 40 wt. % resin, and about 20 wt. % to about 40 wt. % flame-retardant agent.

In some embodiments, the flame-retarding layer (and/or precursor flame-retarding layer) of the composite system may comprise a density. The density of the flame-retarding layer may be one of several different values or fall within one of several different ranges. The density of the flame-retarding layer may be one of the following values: about 1.0 g/cm³, about 1.2 g/cm³, about 1.4 g/cm³, about 1.6 g/cm³, about 1.8 g/cm³, about 2.0 g/cm³, about 2.2 g/cm³, about 2.4 g/cm³, about 2.6 g/cm³, about 2.8 g/cm³, or about 3.0 g/cm³. It is within the present disclosure for the density of the flame-retarding layer to fall within one of the following ranges: less than about 3.0 g/cm³, less than about 2.8 g/cm³, less than about 2.6 g/cm³, less than about 2.5 g/cm³, about 0.5 g/cm³ to about 3.0 g/cm³, about 0.5 g/cm³ to about 2.5 g/cm³, about 1.0 g/cm³ to about 3.0 g/cm³, about 1.0 g/cm³ to about 2.5 g/cm³, about 1.5 g/cm³ to about 3.0 g/cm³, or about 1.5 g/cm³ to about 2.5 g/cm³.

In some embodiments, the flame-retarding layer (e.g., the cured flame-retarding layer) may be a particular thickness or fall within one of several different ranges. In a set of ranges, the flame-retarding layer thickness is one of the following ranges: less than about 10 mm, less than about 5 mm, less than about 2 mm, greater than about 0.5 mm, greater than about 1 mm, greater than about 2 mm, about 0.5 mm to about 10 mm, about 0.5 mm to about 5 mm, about 0.5 mm to about 4 mm, about 0.5 mm to about 3 mm, about 1 mm to about 10 mm, about 1 mm to about 5 mm, about 1 mm to about 4 mm, about 1 mm to about 3 mm, about 2 mm to about 10 mm, about 2 mm to about 5 mm, about 2 mm to about 4 mm, or about 2 mm to about 3 mm. In some embodiments, the flame-retarding layer has a thickness of about 0.5 mm to about 3 mm.

The precursor flame-retarding layer (e.g., uncured flame-retarding layer) can be molded and/or compressed to provide the flame-retarding layer (e.g., the cured flame-retarding layer) of the composite system having a particular thickness. In some embodiments, the uncured flame-retarding layer may be a particular thickness or fall within one of several different ranges. In a set of ranges, the uncured flame-retarding layer thickness is one of the following ranges: less than about 10 mm, less than about 5 mm, less than about 2 mm, greater than about 0.5 mm, greater than about 1 mm, greater than about 2 mm, about 0.5 mm to about 10 mm, about 0.5 mm to about 5 mm, about 0.5 mm to about 4 mm, about 0.5 mm to about 3 mm, about 1 mm to about 10 mm, about 1 mm to about 5 mm, about 1 mm to about 4 mm, about 1 mm to about 3 mm, about 2 mm to about 10 mm, about 2 mm to about 5 mm, about 2 mm to about 4 mm, or about 2 mm to about 3 mm. In some embodiments, the uncured flame-retarding layer has a thickness of about 0.5 mm to about 3 mm.

In some embodiments, the flame-retarding layer (and/or precursor flame-retarding layer) has a flexural strength of greater than about 150 MPa. For example, the flame-retarding layer may have a flexural strength of about 150 MPa to about 400 MPa, such as about 150 MPa to about 350 MPa.

In some embodiments, the flame-retarding layer (and/or precursor flame-retarding layer) has a flexural modulus of greater than about 9 GPa. For example, the flame-retarding layer may have a flexural modulus of about 9 GPa to about 25 GPa, such as about 9 GPa to about 18 GPa.

In some embodiments, the flame-retarding layer (and/or precursor flame-retarding layer) has a thermal conductivity (conduction) of greater than about 0.1 W/mK. For example, the flame-retarding layer may have a thermal conductivity of about 0.1 W/mK to about 50 W/mK, such as about 1 W/mK to about 10 W/mK.

### Shielding Layer.

In some embodiments, the shielding layer (and/or precursor shielding layer) of the composite system comprises a molding formulation and a metallic fabric. In some embodiments, the shielding layer (and/or precursor shielding layer) of the composite system comprises, for example, a molding formulation and a metal. In some embodiments, the molding formulation of the shielding layer (and/or precursor shielding layer) of the composite system is the same molding formulation of the flame-retarding layer of the composite system. In some embodiments, the molding formulation of the shielding layer (and/or precursor shielding layer) of the composite system may comprise a resin and a particle. In some embodiments, the shielding layer (and/or precursor shielding layer) of the composite system comprises, for example, a resin, a particle, and a metal. In some embodiments, the resin of the shielding layer (and/or precursor shielding layer) of the composite system includes the same resin of the flame-retarding layer of the composite system. In some embodiments, the shielding layer (and/or precursor shielding layer) of the composite system does not include a fiber, such as a discontinuous fiber, a chopped fiber, or a combination thereof. In some embodiments, the shielding layer of the composite system is an uncured shielding layer (e.g., precursor shielding layer) or a cured shielding layer. In some embodiments, the precursor shielding layer of the composite system is an uncured shielding layer. In some embodiments, the shielding layer of the composite system comprises a cured composition of the precursor shielding layer.

In some embodiments, the metallic fabric comprises a metal. The metallic fabric may be selected from the group consisting of a metallic wire fabric, a metal-coated polymer fabric, and a combination thereof. In one embodiment, the metal of the shielding layer may comprise a metallic wire fabric. In another embodiment, the metal of the shielding layer may comprise a metal-coated polymer fabric. A metallic fabric, such as a metallic wire fabric or a metal-coated polymer fabric, may be a woven (e.g., a weave structure) or a nonwomen.

In some embodiments, the metallic fabric comprises a continuous fiber (e.g., long fiber), such as a metal wire, a metal-coated fiber, or a combination thereof. The metal wire, for example, may consist of a metal. The metal-coated fiber, for example, may be a glass fiber, a basalt fiber, a carbon fiber, a polymer fiber (e.g., a polyester fiber), or any combination thereof that is coated with a metal. In some embodiments, the metallic fabric of the shielding layer of the composite system may comprise a polyester fiber coated with a metal, such as copper, nickel, aluminum, or any combination thereof.

In some embodiments, the metallic fabric is a nonwoven or a woven. A woven, for example, may comprise a weave structure selected from the group consisting of plain weave, satin, twill, and any combination thereof. A metallic wire fabric, for example, may be a woven (i.e., comprises a weave structure) or a nonwomen based on the arrangement of metal wire. In some embodiments, the metal of shielding layer of the composite system may comprise a metal-coated polymer fabric. A metal-coated polymer fabric, for example, may be a woven (e.g., comprises a weave structure) or a nonwomen based on the arrangement of metal-coated fibers.

Examples of suitable metals, include but are not limited to, copper, nickel, aluminum, silver, gold, iron, and the like. In some embodiments, the metal includes copper, aluminum, or combination thereof. In some embodiments, the metallic fabric (e.g., metallic wire fabric and/or a metal-coated polymer fabric) comprises a weave structure selected from the group consisting of plain weave, satin, twill, and any combination thereof.

In some embodiments, the shielding layer (and/or precursor shielding layer) of the composite system excludes a metal sheet, such as a metal foil sheet (e.g., an aluminum foil sheet or a steel foil sheet). In some embodiments, the metallic fabric may provide for an improvement in burst resistance of the composites in accordance with the present disclosure.

In some embodiments, the metallic fabric comprises a thickness of about 10 micron or greater. In some embodiments, the metallic fabric may be a particular thickness or fall within one of several different ranges. In a set of ranges, the metallic fabric thickness is one of the following ranges: less than about 1 mm, less than about 0.5 mm, less than about 0.1 mm, less than about 0.05 mm, greater than about 10 micron, greater than about 25 micron, greater than about 50 micron, greater than about 100 micron, about 0.01 mm to about 1 mm, about 0.01 mm to about 0.5 mm, about 0.01 mm to about 0.1 mm, about 0.1 mm to about 1 mm, or about 0.1 mm to about 0.5 mm.

In some embodiments, the shielding layer (and/or precursor shielding layer) comprises at least one layer of a metallic fabric. For example, the shielding layer may comprise 1 to 5 layers, such as 1, 2, 3, 4, or 5 layers, of a metallic fabric.

In some embodiments, the shielding layer (and/or precursor shielding layer) may be a particular thickness or fall within one of several different ranges. In a set of ranges, the shielding layer thickness is one of the following ranges: less than about 5 mm, less than about 2 mm, less than about 1 mm, greater than about 0.01 mm, greater than about 0.05 mm, greater than about 0.1 mm, greater than about 0.5 mm, about 0.01 mm to about 5 mm, about 0.01 mm to about 2 mm, about 0.01 mm to about 1 mm, about 0.01 mm to about 0.5 mm, about 0.01 mm to about 0.1 mm, about 0.1 mm to about 5 mm, about 0.1 mm to about 2 mm, about 0.1 mm to about 1 mm, or about 0.1 mm to about 0.5 mm.

In some embodiments, the shielding layer and/or the metallic fabric of the shielding layer (and/or precursor shielding layer) is configured to meet (i.e., certified by) a testing standard, such as ASTM D4935 or IEEE299.

In some embodiments, the metallic fabric of the shielding layer (and/or precursor shielding layer) of the composite system is impregnated (also referred to as pre-impregnated) with the molding formulation. For example, a metallic fabric impregnated with the molding formulation may comprise the metallic fabric saturated with the molding formulation, including molding formulation in the spaces between the metal wires and/or metal-coated fibers of the metallic fabric. In some embodiments, the metal part of shielding layer of the composite system may be pre-impregnated with the same molding formulation of the flame-retarding layer of the composite system. In some embodiments, the metal part of the shielding layer of the composite system may be pre-impregnated with the same resin of the flame-retarding layer of the composite system.

In one embodiment, the shielding layer (and/or precursor shielding layer) of the composite system may comprise copper/aluminum and polyester with the following properties: surface resistance<0.05 ohm; frequency range; and 30 MHz to 30 GHz; Damping (dB): 95˜64 dB.

In some embodiments, the resin of the shielding layer (and/or precursor shielding layer) of the composite system may comprise a thermoset resin. Examples of plastic polymers or resins suitable for forming the shielding layer of the composite system include a polyester resin, vinyl ester resin, epoxy resin, and the like. In some embodiments, the resin of shielding layer of the composite system may comprise an unsaturated polyester resin. In some embodiments, the thermoset resin comprises an additive, such as a catalyst (e.g., an initiator and/or a curing agent).

In some embodiments, the particle of the shielding layer (and/or precursor shielding layer) of the composite system may comprise a flame-retardant agent. Flame-retardant agents may be chemicals applied to materials to prevent burning or slow the spread of fire. Examples of flame-retardant agents suitable for forming the shielding layer of the composite system include selected from the group consisting of aluminum trihydrate, calcium carbonate, phosphorus, and the like.

In some embodiments, the shielding layer (and/or precursor shielding layer) of the composite system may optionally include one or more additives. Additives including, but not limited to, catalysts (e.g., an initiator and/or a curing agent), inhibitors, coloring agents, and wetting agents may be added to the molding formulation to improve the molding process and provide additional properties to the composite system. Examples of catalysts (e.g., initiators and/or curing agents) suitable for the molding formulation of the composite system are organic peroxides, such as methyl ethyl ketone peroxide, t-butylperoxybenzoate (TBPB), benzoyl peroxide and cumene hydroperoxide (CHP), benzyl trimethyl ammonium chloride (BTMAC) or TBPB/t-butyl peroxy octoate (TBPO), available from Nouryon Products.

In some embodiments, the molding formulation of the shielding layer (and/or precursor shielding layer) of the composite system may comprise a weight percentage of resin. The weight percent of resin in the molding formulation may be one of several different percentages or fall within one of several different ranges. In some embodiments, the molding formulation comprises a weight percent of about 60% to about 95% of resin. The weight percent of the resin in the molding formulation may be one of the following values: about 60%, about 65%, about 70%, about 75%, about 80%, about 85%, about 90%, and about 95%. It is within the present disclosure for the weight percent of the resin to fall within one of the following ranges: greater than about 50%, greater than about 60%, greater than about 65%, greater than about 70%, greater than about 75%, less than about 95%, less than about 90%, less than about 85%, less than about 80%, about 60% to about 90%, about 60% to about 85%, about 60% to about 80%, about 70% to about 95%, about 70% to about 90%, about 70% to about 85%, and about 70% to about 80%.

In some embodiments, the molding formulation of the shielding layer (and/or precursor shielding layer) of the composite system may comprise a weight percentage of a particle. The weight percent of particle in the molding formulation may be one of several different percentages or fall within one of several different ranges. In some embodiments, the molding formulation comprises a weight percent of about 5% to about 40% of particle. The weight percent of the particle in the molding formulation may be one of the following values: about 5%, about 10%, about 15%, about 20%, about 25%, about 30%, about 35%, and about 40%. It is within the present disclosure for the weight percent of the particle to fall within one of the following ranges: greater than about 5%, greater than about 10%, greater than about 15%, greater than about 20%, less than about 40%, less than about 35%, less than about 30%, less than about 25%, about 5% to about 35%, about 5% to about 30%, about 5% to about 25%, about 10% to about 40%, about 10% to about 35%, about 10% to about 30%, and about 10% to about 25%.

In some embodiments, the molding formulation of the shielding layer (and/or precursor shielding layer) of the composite system may comprise a weight percentage of additive. The weight percent of additive in the molding formulation may be one of several different percentages or fall within one of several different ranges. In some embodiments, the molding formulation comprises a weight percent of less than about 5% of additive. The weight percent of the additive in the molding formulation may be one of the following values: about 0.1%, about 0.5%, about 1%, about 2%, about 3%, about 4%, and about 5%. It is within the present disclosure for the weight percent of the additive to fall within one of the following ranges: less than about 5%, less than about 4%, less than about 3%, less than about 2%, less than about 1%, less than about 0.5%, about 0.1% to about 5%, about 0.1% to about 4%, about 0.1% to about 3%, about 0.1% to about 2%, about 0.1% to about 1%, about 1% to about 5%, about 1% to about 4%, about 1% to about 3%, and about 1% to about 2%.

In some embodiments, the shielding layer (and/or precursor shielding layer) of the composite system may comprise a weight percentage of molding formulation. The weight percent of molding formulation in the shielding layer may be one of several different percentages or fall within one of several different ranges. In some embodiments, the shielding layer comprises a weight percent of about 10% to about 99% of molding formulation. In some embodiments, the shielding layer comprises a weight percent of about 10% to about 99% of molding formulation. The weight percent of the molding formulation in the shielding layer may be one of the following values: about 10%, about 15%, about 20%, about 25%, about 30%, about 35%, about 40%, about 45%, about 50%, about 55%, about 60%, about 65%, about 70%, about 75%, about 80%, about 85%, about 90%, and about 95%. It is within the present disclosure for the weight percent of the molding formulation to fall within one of the following ranges: greater than about 10%, greater than about 25%, greater than about 50%, less than about 99%, less than about 95%, less than about 90%, less than about 75%, about 10% to about 95%, about 10% to about 75%, about 10% to about 50%, about 25% to about 99%, about 25% to about 95%, about 25% to about 90%, about 25% to about 75%, about 25% to about 50%, about 50% to about 99%, about 50% to about 95%, about 50% to about 90%, about 50% to about 75%, and about 50% to about 25%.

In some embodiments, the shielding layer (and/or precursor shielding layer) of the composite system may comprise a weight percentage of additive. The weight percent of additive in the shielding layer may be one of several different percentages or fall within one of several different ranges. In some embodiments, the shielding layer comprises a weight percent of less than about 5% of additive. The weight percent of the additive in the shielding layer may be one of the following values: about 0.1%, about 0.5%, about 1%, about 2%, about 3%, about 4%, and about 5%. It is within the present disclosure for the weight percent of the additive to fall within one of the following ranges: less than about 5%, less than about 4%, less than about 3%, less than about 2%, less than about 1%, less than about 0.5%, about 0.1% to about 5%, about 0.1% to about 4%, about 0.1% to about 3%, about 0.1% to about 2%, about 0.1% to about 1%, about 1% to about 5%, about 1% to about 4%, about 1% to about 3%, and about 1% to about 2%.

In some embodiments, the composite system according to the present disclosure may provide an average shielding effectiveness (damping) of greater than about 10 dB a frequency range of about 30 MHz to about 1.5 GHz. For example, the composite may provide an average shielding effectiveness of greater than about 20 dB, greater than about 25 dB, greater than about 30 dB, greater than about 40 dB, greater than about 50 dB, or greater than about 60 dB in a frequency range of about 30 MHz to about 1.5 GHz. In some embodiments, the composite system may provide an average shielding effectiveness (damping) of about 10 dB to about 100 dB, about 25 dB to about 100 dB, or about 50 dB to about 100 dB in a frequency range of about 30 MHz to about 1.5 GHz.

In some embodiments, the composite system according to the present disclosure may be a particular thickness or fall within one of several different ranges. In a set of ranges, the composite thickness is one of the following ranges: less than about 10 mm, less than about 5 mm, less than about 2 mm, greater than about 0.5 mm, greater than about 1 mm, greater than about 2 mm, about 0.5 mm to about 10 mm, about 0.5 mm to about 5 mm, about 0.5 mm to about 4 mm, about 0.5 mm to about 3 mm, about 1 mm to about 10 mm, about 1 mm to about 5 mm, about 1 mm to about 4 mm, about 1 mm to about 3 mm, about 2 mm to about 10 mm, about 2 mm to about 5 mm, about 2 mm to about 4 mm, or about 2 mm to about 3 mm. In some embodiments, the composite thickness is about 0.5 mm to about 3 mm. In some embodiments, the composite thickness is less than or equal to the thickness of the precursor flame retarding layer.

Manufacturing complex-shaped enclosures by co-molding a precursor flame retardant layer and a precursor shielding layer including, for example, a continuous fabric that is a pre-impregnated fabric presents a challenge. The composite system according to exemplary embodiments of the present disclosure satisfies a long-felt need for a composite system that includes many if not all the features of structural strength and stiffness, flame-retarding performance, and shielding capability. Additionally, the composite system according to exemplary embodiments of the present disclosure satisfies a long-felt need for a lightweight composite system at an economical cost. Others have failed to provide a composite system that achieves combinations of these features as reflected in the appended claims. This failure is a result of the many features being associated with competitive design choices.

As an example, others have created composite systems that based on design choices possess flame protection but fail to provide comparable strength and stiffness and economical cost. In comparison, the composite system of the present disclosure overcomes the challenges and failures of others by including a flame-retarding layer and a shielding layer to balance the properties of structural strength and stiffness, flame-retarding performance, and shielding capability while maintaining a low cost.

In comparison, the composite system of the present disclosure overcomes the challenges and failures of others by using a thermoset resin in both the flame retarding layer and the shielding layer without the need for an adhesive and can provide a cured composite in a low cost and efficient co-molding process. It is an object of the present disclosure to provide a low cost composite that combines the EMI shielding effect of a shielding layer with the fire protection and strength of a flame-retarding layer.

In accordance with the present disclosure, the composite system includes a flame-retarding layer and a shielding layer. Additionally, the present disclosure relates to composite systems including a flame-retarding layer comprising a molding formulation and a fiber, and a shielding layer comprising the molding formulation and a metallic fabric comprising a metal.

The present disclosure relates to composite systems for use in battery enclosures that may provide for performance structural use for electric vehicles (EVs), flame retarding capability as defined by UL standards, and electromagnetic interference (EMI) shielding at a commercial level.

In some examples, the automotive industry is replacing internal combustion engines with electric motors or a combination of an electric motor and an internal combustion engine, thereby lowering the environmental impact of automobiles. However, this change in propulsion technology is not without technological hurdles, as the use of an electric motor entails the need for low-cost, rechargeable batteries with high energy density, long service life, and diverse operating conditions.

In some examples, thermal runaway poses a challenge. Thermal runaway can occur in rechargeable batteries, such as lithium-ion cells, when the internal reaction rate increases to the point where more heat is generated than can be removed from the battery, resulting in a further increase in both the reaction rate and heat generation. Eventually, the amount of heat generated is large enough that it leads to the destruction of the battery cell (e.g., by overpressure (bursting) or by the emission of gases). In addition, this can lead to the development of a fire.

Thermal runaway can be caused, for example, by a short circuit within the cell, improper use of the cell, manufacturing defects, or extreme outside temperatures. In the case of a battery pack used in an electric vehicle, which contains several battery cells, a car accident can be the cause of several cells within the battery pack suffering thermal runaway at the same time.

During a thermal runaway, a large amount of thermal energy is released rapidly, heating the entire cell to a temperature of 850° C. or more. The increased temperature of the thermal runaway cell also raises the temperature of adjacent cells within the battery pack. If the temperature of the neighboring cells increases unhindered, they can also become thermally runaway. This cascade effect can mean that when a single cell is thermally runaway, all cells in the entire battery pack end up thermally runaway.

Battery packs may comprise an enclosure that serves to protect the battery cells and contains devices that serve to air-condition and control the battery cells. By using specially configured enclosures, the risk caused by a short circuit during storage and/or handling can be reduced.

Battery housings may include glass fiber reinforced plastic. For example, comparative battery packs may include a protective layer made of a glass fiber material coated with a polymer is arranged inside a housing made of a stable material. If a battery fails, the fabric may retain the resulting gases and the housing may absorb the resulting forces.

Flame retardant grade sheet molding compounds (SMCs) may be used as battery enclosure materials. Flame retardant grade SMCs may have excellent structural properties (over 150 Mpa flexural strength and over 9 GPa flexural modulus) with sufficient flame retarding efficiency to meet OEM requirements such as UL 94 V0 and UL94 5VA at about 3 mm thickness.

In some circumstances, electromagnetic interference (EMI) shielding and energy dissipation is needed for stable electronic operation. EMI shielding may be integrated into the casing of electronic devices by coating with EMI paint, molding with functional filler such as metallic flakes, or laminating/bonding with a functional layer.

Flake filler such as nickel may be compounded into a polymer such as ABS (acrylonitrile butadiene styrene) and molded into an appliance case. While the filler can increase EMI shield effect, too much content with non-uniform distribution could cause a tradeoff defect in mechanical properties. Alternatively, a thick fabric material for EMI shielding may provide efficient shielding protection due to the tight structure, but may be difficult to process to the desired form. While the fabric used to make composites may be prepared by prepregging and molding, there is a tradeoff in such a high cost consuming process.

Battery enclosures may be EMI shielded. For example, a cover structure for a battery of an electric vehicle may be made of a SMC (sheet molding compound) base body with a fire protection coating and an EMI shielding layer. The fire protection coating, the SMC base body, and the EMI shielding layer may be bonded together in a single operation, such as a bonding press. The fire protection coating and the EMI shielding layer may be provided on opposite sides of the SMC base body. The fire protection coating may be formed by a mica plate. The core idea of the foregoing example is to create a permanently tacky layer on an SMC base body, for which a powder adhesive may be used.

Currently, there is a need for fire retarding materials as a low-cost alternative for fire protection. Thus, an SMC and metallic fabric co-molding process could be an effective way to provide reliable parts at an economical cost. Metallic foil or metal wire fabric can be readily available and widely applied to provide EMI shielding effect, for example unwanted device infringement. A composite provided by SMC co-molding with a reliable EMI shield fabric, may provide an improved EMI shielding effect at a lower cost. Composite systems in accordance with the present disclosure may provide solutions to the need described herein.

To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value.

### EXAMPLES

The following examples and representative procedures illustrate features in accordance with the present disclosure, and are provided solely by way of illustration. They are not intended to limit the scope of the appended claims or their equivalents. Parts and percentages appearing in such examples are by volume, or thickness, unless otherwise stipulated. All ASTM, ISO, UL and other standard test methods cited or referred to in this disclosure are incorporated by reference in their entirety.

### Example 1. Property Improvement by Shielding Layer

An exemplary flame-retarding layer of the composite system in accordance with certain aspects of the present disclosure is provided in the instant example. Characteristic mechanical properties of various grades of flame-retarding layers (e.g., composites made of flame retarding grade SMC) are shown in Table 1. Flame retarding performances also were classified to each grade and are shown in Table 1. Electric Vehicle Battery Enclosure Material Safety (UL 2596) defined the test method for thermal and mechanical performance of battery enclosure materials, specifies the requirements for the evaluation of EV battery enclosure materials.

TABLE 1

| | Middle performance | | High performance | |
|---|---|---|---|---|
| | Flame | High flame | Flame | High flame |
| | retarding | retarding | retarding | retarding |
| Flexural | 150~ | | 250- | |
| strength | 250 Mpa | | 350 Mpa | |
| Flexural | 9-12 GPa | | 12-18 GPa | |
| modulus | | | | |
| UL94 | 2.0 mm | 1.5 mm | 2.0 mm | 1.5 mm |
| V0* | or more | or more | or more | or more |
| UL94 | 3 mm | 2 mm | 3 mm | 2 mm |
| 5VA* | or more | or more | or more | or more |

Note
*thickness requirement to pass the above UL standard test

The addition of the shielding layer (e.g., a layer including a metallic fabric comprising a metal) to a flame-retarding layer (e.g., a layer including a flame retarding grade SMC) may not improve flame-retarding performance but may afford some advantage in mechanical properties such as strength and stiffness.

The tensile and flexural properties of the composite system including a flame-retarding layer and shielding layer were not meaningfully improved because metallic fabric may only contribute the tensile strength on the low strain region in the o-degree direction. However, the triaxial fabric may be used as battery enclosure materials in OEMs like Hyundai and Honda, because it has excellent structural properties, especially burst resistance.

Therefore, the continuous fiber is used as the metallic fabric of the shielding layer of the SMC co-molding process, and may provide for an improvement in burst resistance, not tensile or flexural properties. The wrapping effect by the continuous fiber of the shielding layer may improve the bursting resistance, even though it is not measured as a number. Higher bursting resistance might be needed to pass battery enclosure thermal runaway (BETR) evaluation and the torch and grit (TaG) test. The bursting resistance improvement by metallic fabric may be supported with the aforementioned evaluation.

### Example 2. Compression Molding Process of Composite System

An exemplary method of a compression co-molding process of the composite system in accordance with certain aspects of the present disclosure is provided in the instant example.

The composite system (i.e., laminates) including a precursor flame-retarding layer (such as a flame-retarding SMC) and a precursor shielding layer can be cured in a compression molding process under processing conditions such as 150° C./3 minutes and somewhat delayed up to 50% if the more complex shaped molding is required. In-mold pressure may be greater than 1000 psi, and vacuum may be 635 mmHg (90 sec).

### Example 3. Shielding Performance

An exemplary method of testing the shielding performance of the metals used in the shielding layer of a composite in accordance with certain aspects of the present disclosure is provided in the instant example. Many commercial EMI shielding material manufacturers assert that their commercial EMI shielding material can be used as a shielding layer in a composite with suitable compression molding parameters. Certain EMI shielding materials can provide EMI shielding data through a frequency range of 100 kHz to 20 GHz. Commercially available metallic fabrics were tested for cell phone transmission in a simple Faraday bag test. Results are shown in Table 2. A “pass” is indicated in the cell phone test for materials that prevented receiving a call, and a “fail” is indicated in the cell phone test for materials that allowed for receiving a ring.

The shielding performance of the composite system in accordance with certain aspects of the present disclosure may be tested in the manner provided in the instant example, or by a standard such as ASTM D4935 or IEEE299. For example, OEM may request EMI shielding effectiveness testing of a molded composite having a particular set of dimensions. The molded composite, such as a panel or part, would be tested in a certified testing lab with the defined ASTM/IEEE testing standard. The screening test of the instant example may compare the shielding efficiency of the composite system comprising a shielding layer including an EMI shielding material against the shielding efficiency of the EMI shielding material alone.

TABLE 2

| | Cell phone test |
|---|---|
| Metallic Fabric | (700 MHz~39 GHz) |
| Military grade RF fabric | Pass |
| Al foil (3M embossed) | Pass |
| Al foil/Aramid fabric laminate | Pass |
| Company CH - Diamond pattern | Pass |
| Company CH - Plain pattern | Pass |
| Company CJO plain 50 | Pass |
| Company CJO plain 80 | Pass |
| Company CJI Rip | Pass |
| Company CJI Diamond pattern | Pass |
| Company CJI Plain pattern | Pass |
| Company CST plain 80 | Pass |
| Company CST plain 90 | Pass |
| Company CZS 39 | Pass |
| Carbon fiber unwoven (2 plies) | Fail |
| Al coated glass fabric, 400 GSM | Pass |
| Pure Copper mesh (180M) | Pass |

1. A composite system comprising
a flame-retarding layer comprising a molding formulation and a fiber; and
a shielding layer comprising the molding formulation and a metallic fabric comprising a metal.

2. The composite system of claim 1, wherein the composite system is free of an adhesive.

3. The composite system of claim 1, wherein the molding formulation comprises a resin and a particle.

4. The composite system of claim 3, wherein the resin comprises a thermoset resin.

5. The composite system of claim 4, wherein the thermoset resin is selected from the group consisting of polyester, vinyl ester, epoxy, and any combination thereof.

6. The composite system of claim 1, wherein the fiber is a carbon fiber, a glass fiber, or combination thereof.

7. The composite system of claim 1, wherein the fiber is a discontinuous fiber.

8. The composite system of claim 7, wherein the flame-retarding layer has a flexural strength of greater than about 150 MPa, a flexural modulus of greater than about 9 GPa, and a thermal conduction of greater than about 0.1 W/mK.

9. The composite system of claim 3, wherein the particle is a flame-retardant agent selected from the group consisting of aluminum trihydrate, calcium carbonate, phosphorus, and any combination thereof.

10. The composite system of claim 1, wherein the metal is selected from the group consisting of copper, nickel, aluminum, silver, gold, iron, and any combination thereof.

11. The composite system of claim 1, wherein the metallic fabric selected from the group consisting of a metallic wire fabric, a metal-coated polymer fabric, and a combination thereof.

12. The composite system of claim 11, wherein the metallic fabric is a nonwoven, or a woven comprising a weave structure selected from the group consisting of plain weave, satin, twill, and any combination thereof.

13. The composite system of claim 11, wherein the metallic fabric comprises a thickness of about 10 micron or greater.

14. The composite system of claim 11, wherein the metallic fabric is impregnated with the molding formulation.

15. A composite system comprising:
a flame-retarding layer comprising a thermoset resin, a flame-retardant agent, and a discontinuous fiber, wherein the discontinuous fiber is distributed throughout the flame-retarding layer; and
a shielding layer comprising the thermoset resin, the flame-retardant agent, and a metallic fabric comprising a metal, wherein the metallic fabric is saturated with the thermoset resin and the flame-retardant agent;
wherein the flame-retarding layer and the shielding layer are arranged to be in direct contact.

16. The composite system of claim 15, wherein the thermoset resin is selected from the group consisting of polyester, vinyl ester, epoxy, and any combination thereof.

17. The composite system of claim 15, wherein the metallic fabric selected from the group consisting of a metallic wire fabric, a metal-coated polymer fabric, and a combination thereof.

18. A method of preparing a composite system according to claim 1, the method comprising
compression molding a precursor flame-retarding layer and a precursor shielding layer, wherein the compression molding comprises co-molding the precursor flame-retarding layer and the precursor shielding layer, thereby forming the composite system.

19. The method of claim 18, wherein the method comprises:
(i) contacting the precursor flame-retarding layer with the precursor shielding layer, and
(ii) placing the precursor flame-retarding layer and the precursor shielding layer into a compression mold,
wherein steps (i) and (ii) are performed prior to compression molding.

20. The method of claim 19, wherein step (i) is performed prior to step (ii), or step (i) and step (ii) are performed at the same time.
